(19) United States
(12) Patent Application Publication
(10) Pub. No.: US 2021/0323762 A1
(43) Pub. Date: Oct. 21, 2021

(54) A NEW TYPE OF WATERPROOF INDUCTIVE WASTE BIN

(71) Applicant: FUJIAN NASHIDA ELECTRONIC INCORPORATED COMPANY, Fuzhou (CN)

(72) Inventors: Xin WANG, Minhou Fujian (CN); Wenbin YE, Minhou Fujian (CN); Shaoming CHEN, Minhou Fujian (CN); Xiaoqin HE, Minhou Fujian (CN)

(73) Assignee: Fujian Nashida Electronic Incorporated, Minhou Fujian (CN)

(21) Appl. No.: 17/272,353

(22) PCT Filed: Mar. 14, 2019
(86) PCT No.: PCT/CN2019/078192

§ 371 Date: Mar. 1, 2021

(30) Foreign Application Priority Data
Sep. 17, 2018 (CN) 201821513022.8

(51) Int. Cl. B65F 1/16; B65F 1/08

(52) U.S. Cl. CPC B65F 1/1638; B65F 2210/167; B65F 2001/1676; B65F 1/08

(57) ABSTRACT

The present invention relates to a new type of waterproof inductive waste bin, including an upper barrel body and a lower barrel body, said upper barrel body includes a barrel lid, a barrel head, a middle body seat, an induction control circuit board and a barrel lid driving mechanism, characterized in that: said barrel head and middle body seat are fastened to form a closed annular inner cavity, said annular inner cavity is provided with a first sealing element at the outer side of the fastening, said induction control circuit board and barrel lid driving mechanism are installed in the annular inner cavity. The structure of the present invention is reasonably designed, the induction control circuit board and the lid driving mechanism of the induction waste bin are installed in the closed annular inner cavity, and the sealing element is provided at the fastening around the annular inner cavity to achieve better isolation from the external water and air of the waste bin, which has good waterproof, moisture-proof and anti-corrosion performance in use, and greatly improves the reliability and service life of the induction waste bin.

### FIELD AND BACKGROUND OF THE INVENTION

The present invention relates to a new type of waterproof inductive waste bin.

The waterproof, moisture-proof and anti-corrosion properties of the existing inductive waste bins are relatively poor, when the inductive waste bins are in use, they will inevitably encounter trash containing water, and it is easy to spill water onto the bins when throwing the trash, while the trash in the bins will release moisture and corrosive gases, which will cause erosion to the circuit boards and mechanical parts on the inductive waste bins and shorten the service life of the inductive waste bins significantly. Moreover, in the long-term use of the inductive waste bin, the upper body of the bin is prone to stubborn dirt, which is difficult to remove without flushing with water and can easily breed harmful bacteria; if flushed with water, it will cause damage to the circuitry and render the inductive waste bin unusable.

### SUMMARY OF THE INVENTION

The present invention makes improvements to the problems existing in the prior art, that is, the technical problem to be solved by the present invention is to provide a new type of waterproof inductive waste bin, which not only has a reasonable structural design, but also has good waterproof, moisture-proof and anti-corrosion properties.

In order to achieve the above purpose, the technical solution adopted by the present invention is: a new type of waterproof inductive waste bin, including an upper barrel body and a lower barrel body, said upper barrel body includes a barrel lid, a barrel head, a middle body seat, an induction control circuit board and a barrel lid driving mechanism, characterized in that: said barrel head and middle body seat are fastened to form a closed annular inner cavity, said annular inner cavity is provided with a first sealing element at the outer side of the fastening, said induction control circuit board and barrel lid driving mechanism are installed in the annular inner cavity.

Further, a second sealing element is provided at the inner side of said annular inner cavity where it is fastened.

Further, the upper end of the outer side and the upper end of the inner side of the middle body seat are provided with ring-shaped fastening recesses, said first sealing element and second sealing element are installed in the fastening recesses located on the outer side and the fastening recesses located on the inner side respectively; the lower end of the outer side and the lower end of the inner side of the barrel head are provided with ring-shaped convex bars, the convex bars located on the inner and outer sides fit into the snap-in recesses on the inner and outer sides respectively and squeeze down on the second sealing element and the second sealing element respectively.

Further, both the first sealing element and the second sealing element are ring-shaped seals.

Further, a battery compartment is provided at the bottom of the front end of said middle body seat for installing a battery for supplying power to the induction control circuit board and the lid driving mechanism, a battery cover plate is fastened to the lower port of said battery compartment, and a third sealing element is provided between said battery cover plate and the battery compartment.

Further, an annular recess is provided in the upper outer wall of said battery cover plate, said third sealing element is installed in the annular recess, and the upper end of the battery cover plate is fastened to the inner wall of the battery compartment through the third sealing element to prevent water vapor from entering the battery compartment.

Further, said third sealing element is a sealing ring.

Compared with the existing technology, the present invention has the following effects: the structure of the present invention is reasonably designed, the induction control circuit board and the lid driving mechanism of the inductive waste bin are installed in the closed annular inner cavity, and the sealing strip is set at the clasp around the annular inner cavity to achieve better isolation from the external water vapor of the waste bin, which has good waterproof, moisture-proof and anti-corrosion performance in use, and greatly improves the reliability and service life of the inductive waste bin; at the same time, the battery compartment on the inductive waste bin is also sealed by the sealing ring, which can prevent water vapor from entering the annular inner cavity through the battery compartment and further improve the waterproof effect.

### BRIEF DESCRIPTION OF THE DRAWINGS

FIG. 1 is a schematic diagram of the construction of the present invention embodiment;

FIG. 2 is a schematic diagram of the disassembled state of the upper barrel body and the lower barrel body in the present invention embodiment;

FIG. 3 is a schematic diagram of the structure of the upper barrel body in the present invention embodiment;

FIG. 4 is a schematic diagram of the structure of the middle body seat in the present invention embodiment;

FIG. 5 is a schematic diagram of the partial section of the head of the barrel and the middle body seat in the present invention embodiment;

FIG. 6 is a schematic diagram of the disassembled state of the battery cover plate and the middle body seat in the present invention embodiment;

FIG. 7 is a schematic diagram of the partial section of the battery cover plate cooperating with the middle body seat in the present invention embodiment.

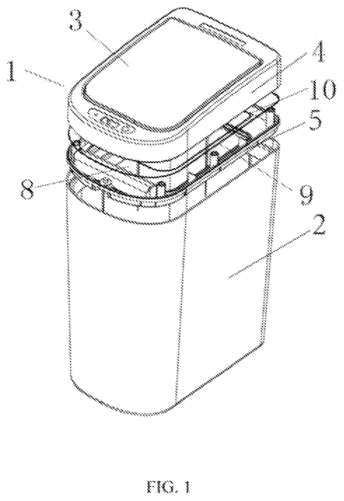

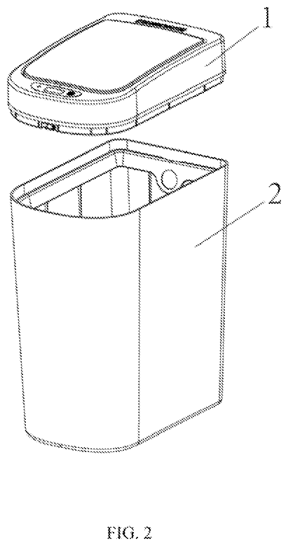

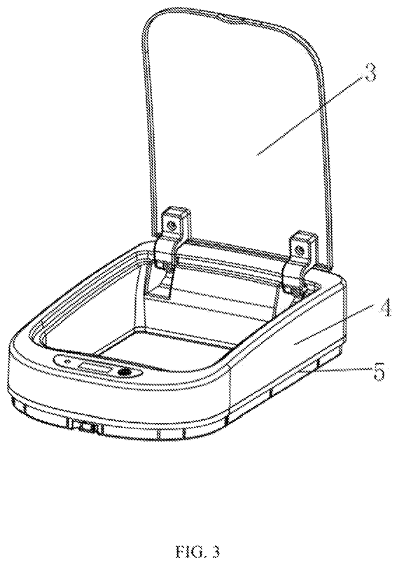

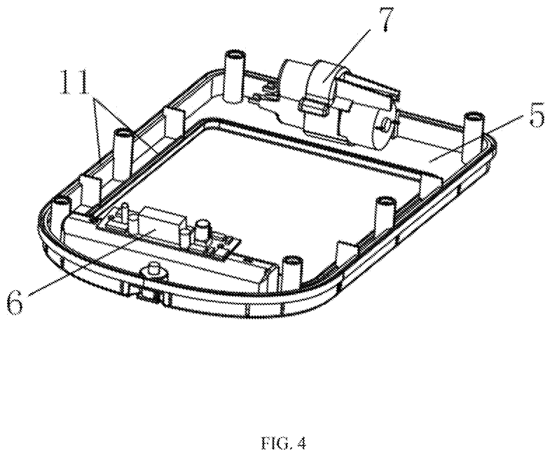

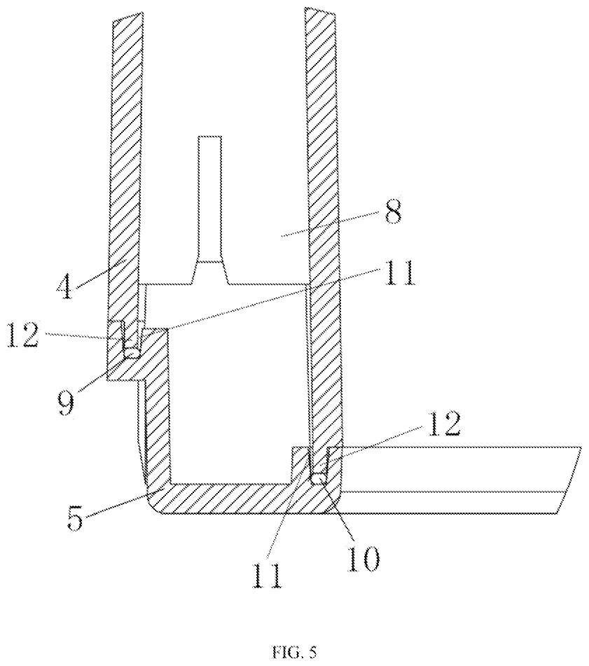

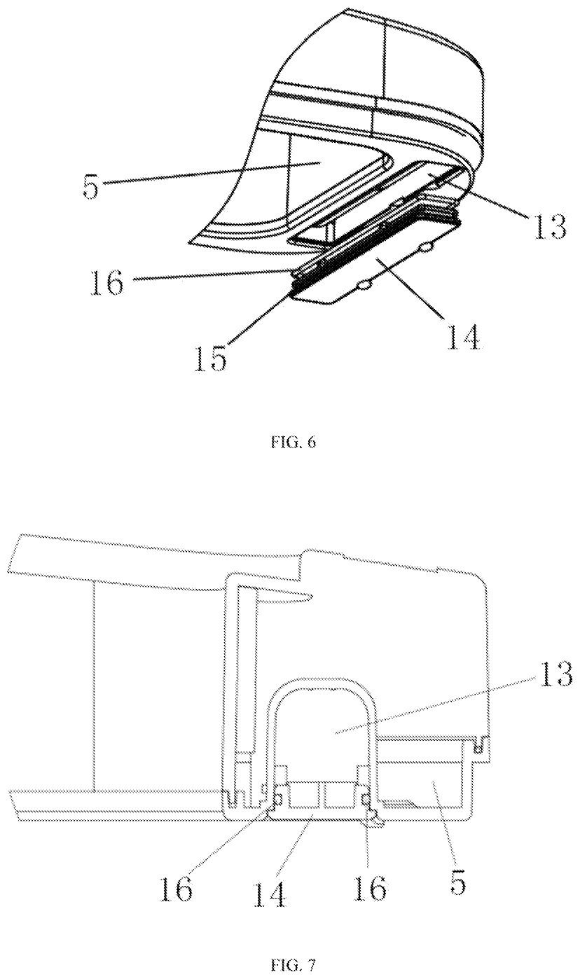

In the figure: 1—upper barrel body; 2—lower barrel body; 3—barrel lid; 4—barrel head; 5—middle body seat; 6—induction control circuit board; 7—barrel lid driving mechanism; 8—annular inner cavity; 9—first sealing element; 10—second sealing element; 11—snapping recess; 12—convex bar; 13—battery compartment; 14—battery cover plate; 15—annular recess; 16—third sealing element.

### DESCRIPTION OF THE PREFERRED EMBODIMENTS

The present invention will be further described in detail in combination with the drawings and the specific embodiments.

As shown in Figures I to 7, a new type of waterproof inductive waste bin, including the upper barrel body 1 and the lower barrel body 2, said upper barrel body 1 includes the barrel lid 3, the barrel head 4, the middle body seat 5, the induction control circuit board 6 and the barrel lid drive mechanism 7, the barrel lid 3 is hinged with the rear end of the barrel head 4, the barrel lid drive mechanism 7 under the control of the induction control circuit board 6 drive the barrel lid 3 open and closed; said barrel head 4 and middle body seat 5 are snapped together to form the closed annular inner cavity 8, said annular inner cavity 8 is provided with the first sealing element 9 on the outer side of the snapping, the induction control circuit board 6 and the lid drive mechanism 7 are installed inside the annular cavity 8. When in use, as the barrel lid 3 is closed, the inner fastening of the annular inner cavity 8 is under the cover of the barrel lid, when water splashes onto the upper bucket body, the water flows down from the outer edge to achieve the waterproof effect of the inductive waste bin.

In this embodiment, the second sealing element 10 is provided on the inner side of the ring-shaped inner cavity 8; by providing the second sealing element 10, the inner side of the ring-shaped inner cavity 8 is still sealed when the barrel lid 3 is opened, further achieving the waterproof effect of the inductive waste bin.

In this embodiment, said middle body seat 5 is provided with the annular snapping recess 11 at the upper end of the outer perimeter and at the upper end of the inner perimeter, said first sealing element 9 and second sealing element 10 are installed in the outer snapping recess 11 and the inner snapping recess 11 respectively; the lower end of the outer side and the lower end of the inner side of the barrel head 4 are provided with the ring-shaped convex bar 12, the convex bar 12 located on the inner and outer sides are connected into the snapping recess 11 located on the inner and outer sides respectively and squeeze down on the second sealing element 10 and the first sealing element 9 respectively. By the fit of the convex bar 12 and the snapping recess 11, the barrel head 4 is tightly fastened to the middle body seat 5, and the sealing element is deformed by the compression of the barrel head rib in the snapping recess, sealing the gap between the barrel head and the middle body seat.

In this embodiment, the first sealing element 9 and the second sealing element 10 are both ring-shaped seals.

In this embodiment, the battery compartment 13 is provided at the bottom of the front end of the middle body seat 5 for mounting a battery for powering the induction control circuit board 6 and the lid drive mechanism 7, the battery cover plate 14 is fastened to the lower port of the battery compartment 13, and the third sealing element 16 is provided between the battery cover plate 14 and the battery compartment 13.

In this embodiment, said battery cover plate 14 is provided with the annular recess 15 on the outer wall of the upper end of said battery cover plate 14, said third sealing element 16 is installed in the annular recess 15, and the upper end of the battery cover plate 14 is fastened to the inner wall of the battery compartment 13 through the third sealing element 16 to prevent water vapor from entering the annular inner cavity between the barrel head and the middle body seat through the battery compartment, further achieving the waterproof effect of the inductive waste bin.

In this embodiment, said third sealing element is a sealing ring.

The advantages of the present invention are: the new waterproof inductive waste bin has the induction control circuit board and the lid driving mechanism installed in the annular inner cavity between the barrel head and the middle body seat to achieve better isolation from the external water vapor of the waste bin, which has good waterproof, moisture-proof and anti-corrosion performance when in use, significantly improving the reliability and service life of the inductive waste bin, while the upper body of the waste bin is flushed with water to easily remove dirt; and the battery compartment on the inductive waste bin is also sealed by the sealing ring to prevent water vapor from entering the annular inner cavity through the battery compartment, further improving the waterproof effect.

All variations and modifications made in accordance with the scope of the present invention patent application should be covered by the present invention.

1. A new type of waterproof inductive waste bin, including an upper barrel body and a lower barrel body, said upper barrel body includes a barrel lid, a barrel head, a middle body seat, an induction control circuit board and a barrel lid driving mechanism, characterized in that: said barrel head and middle body seat are fastened to form a closed annular inner cavity, said annular inner cavity is provided with a first sealing element at the outer side of the fastening, said induction control circuit board and barrel lid driving mechanism are installed in the annular inner cavity.

2. A new type of waterproof inductive waste bin according to claim 1, characterized in that: a second sealing element is provided at the inner side of said annular inner cavity where it is fastened.

3. A new type of waterproof inductive waste bin according to claim 2, characterized in that: the upper end of the outer side and the upper end of the inner side of the middle body seat are provided with ring-shaped fastening recesses, said first sealing element and second sealing element are installed in the fastening recesses located on the outer side and the fastening recesses located on the inner side respectively; the lower end of the outer side and the lower end of the inner side of the barrel head are provided with ring-shaped convex bars, the convex bars located on the inner and outer sides fit into the snap-in recesses on the inner and outer sides respectively and squeeze down on the second sealing element and the second sealing element respectively.

4. A new type of waterproof inductive waste bin according to claim 3, characterized in that: both the first sealing element and the second sealing element are ring-shaped seals.

5. A new type of waterproof inductive waste bin according to claim 1, characterized in that: a battery compartment is provided at the bottom of the front end of said middle body seat for installing a battery for supplying power to the induction control circuit board and the lid driving mechanism, a battery cover plate is fastened to the lower port of said battery compartment, and a third sealing element is provided between said battery cover plate and the battery compartment.

6. A new type of waterproof inductive waste bin according to claim 5, characterized in that: an annular recess is provided in the upper outer wall of said battery cover plate, said third sealing element is installed in the annular recess, and the upper end of the battery cover plate is fastened to the inner wall of the battery compartment through the third sealing element to prevent water vapor from entering the battery compartment.

7. A new type of waterproof inductive waste bin according to claim 6, characterized in that: said third sealing element is a sealing ring.
